(19) United States
(12) Patent Application Publication
(10) Pub. No.: US 2012/0131105 A1
(43) Pub. Date: May 24, 2012

(54) Method of obtaining and analyzing real-time opinions and analytical evaluations of distinct moments experienced by users of a social network

(76) Inventor: Victor Andrew Rortvedt, (US)

(21) Appl. No.: 12/951,160

(22) Filed: Nov. 22, 2010

(51) Int. Cl. G06F 15/16

(52) U.S. Cl. 709/205

(57) ABSTRACT

The present invention relates to methods and systems for requesting, analyzing, and displaying both numerical evaluations and text based evaluations of distinct moments within an experience shared by users of a social network. The social network users log-in to a particular event and the social network provides updates consisting of real-time descriptions of distinct moments within the event. The users rate and comment on the moment, and then receive data on the group perception and top comment for that moment, in real time.

### GENERAL FIELD OF THE INVENTION

The invention generally relates to social networks and digital media. More particularly, the invention relates to methods and systems for requesting, collecting, aggregating and analyzing electronic data.

### BACKGROUND AND CIRCUMSTANCES OF THE INVENTION

Social networks and telecommunications platforms have grown rapidly over the past decade. Many digital platforms and social networks encourage their users to share their thoughts, sometimes utilizing tags or analogous devices to indicate the subjects of their thoughts.

Yet no social network or telecommunications platform provides a central clearinghouse to gather and assess the opinions and analysis of its users to shared experiences in real-time. Other digital applications permit users to submit ratings, opinions, analysis and reviews of products, political speeches, films, sports teams, music, etc., but none are designed to thoroughly capture the user's moment by moment reactions to the components of those events. To the degree that other applications permit for “real-time” analytical reactions, they are not organized into communities of individuals responding to the same event, nor do they aggregate “real-time” ratings and evaluations and provide the users of the social network with feedback on valuable analysis or aggregate assessment of that shared event.

This invention allows groups to share experiences with each other via a social network in an organized way that encourages opinion sharing. It provides a mechanism to capture the immediate reactions of individuals before those reactions are mediated by commentators, or before those reactions fade with time. Because this invention can be used anywhere a user has access to a mobile electronic device with an interne or cellular connection, it will be able to capture more honest opinions and reactions than those captured in artificial situations, such as a telephone survey or an in-person televised focus group with reaction meters.

This invention allows individual users to perceive that their opinions have an immediate and meaningful effect on the larger group's opinion of a particular moment. This effect can increase the user's interest in the thing being perceived because it creates a community and asks each user to participate in ways that can be of little to no personal cost to the user.

### SUMMARY OF THE INVENTION

The principal and secondary objects of the invention are to: 1) utilize social networks to aggregate user ratings of shared experiences in real-time; and 2) utilize social networks to obtain and share the most valuable analysis of shared experiences in real-time.

These and other valuable objects are achieved by means of a software program within a social network that requests, collects, aggregates, analyzes, ranks and displays both numerical evaluations and analytical evaluations of shared distinct experiences by the users of a social network. The software will run inside a social network and digital platform accessible via the interne on computers, mobile devices, video game systems, “smart” appliances, and other digital or electronic devices.

The invention works by providing a method for focusing the attention of the users of the social network on a particular moment within a shared experience—for instance, a down in a televised football game or a political candidate's response to a particular debate question—and seeks their immediate and specific feedback on that distinct moment, primarily through two major indicia: 1) by assigning a numerical rating to that moment (generally using the numbers one through nine); and 2) by inputting analytical comments responsive to that moment.

The source of the factual description of each moment within an event may be either employees of the social network, or volunteers who have agreed to serve as source authors for a particular event.

### Numerical Ratings

In the invention's most basic form, users are prompted to share their evaluation of a particular moment in a shared event through the social network by assigning a numerical rating to that particular moment immediately after they experience it. After each moment, the social network displays a summary of that moment and prompts the user for his or her rating. The social network defines what constitutes a “moment” differently based on the event that the user is logged in to. For example, when users view a telecast of the Academy Awards, the social network will refresh with the announcement of an award going to a particular individual or film (e.g., “Best Actress Winner: Halle Berry—Monster's Ball”) after that award is announced, and the user will be prompted to rate their agreement with the award. Each award will constitute a “moment,” whereas in a televised football game, a down will constitute a “moment.” In the context of other types of events, “moments” may be defined differently, with the general guideline that they capture distinct yet complete occurrences within the context of a larger event. Even the commercials that air during the telecast of one of the events mentioned above are such “moments” even though there is no macro-commercial event except the program that the advertisement runs within.

The invention then aggregates the data gathered from the ratings assigned by users and averages the numbers to generate a “group reaction.” This “group reaction” is displayed and revised approximately every one second period for users that are logged in to that event. While one particular user may assign a particular down in a football game a rating of 4, reflecting his or her belief that it was a slightly sub-par play call or execution by the players, the “group reaction” for that down may be 6.13 one second, and then 5.98 the next, eventually stabilizing at 6.03 after a few minutes.

The user may also receive data about various subsets of the entire community logged in to that event. For instance, during a presidential debate, a user may have modified his or her display settings to show ratings along party lines (for those users who have provided their party affiliations). Then after a candidate's response to a question, the user would be able to see that the response has a “group reaction” of 5.01 after a minute, but that it has a “Republican reaction” of 7.82 and a “Democrat reaction” of 3.11. Other potential settings could display reaction based on divisions of age, gender, nationality, length of time on the network, profession, income, and many other metrics.

The invention would also provide users of a social network with the ability to display different views of the group reaction, such as a linear graph that displays the reactions over the duration of the event.

### Analytical Comments

The invention would also provide users of the social network with an opportunity to share their analysis of the “moment” through a text field, or via voice transcription. Users could then enter comments on a particular moment and transmit the comment to the social network. Other users would then be selected via a randomizing (and/or weighted) algorithm to receive comments from other users for their review. After reviewing the comment, the user could then decide to recommend the comment, vote down the comment, or do nothing. The algorithm will then analyze the input from users and re-transmit those comments that were recommended to a progressively larger number of users until a single comment can be assigned the status of “top comment” for that particular moment, reflecting that it had the greatest percentage of recommendations among comments for that moment within the social network. Users could opt to view a record of the “top comment” for each moment within the event that they are logged in to. They could also opt to receive data on the most commented upon moments and the corresponding “top comments.”

After the event concludes, the invention will assemble the “top comment” for each moment into a single “event log,” which could be reviewed as a summary of the opinions of the users of the social network.

### DESCRIPTION OF EACH FIGURE OF THE DRAWING

FIG. 1 of the drawing is a functional flow chart which describes, in linear temporal order, the method by which Claims 1 through 4 operate to result in the generation and display of aggregate average numerical ratings of each distinct shared experience (or “moment”), as well as other mathematical or demographic analyses.

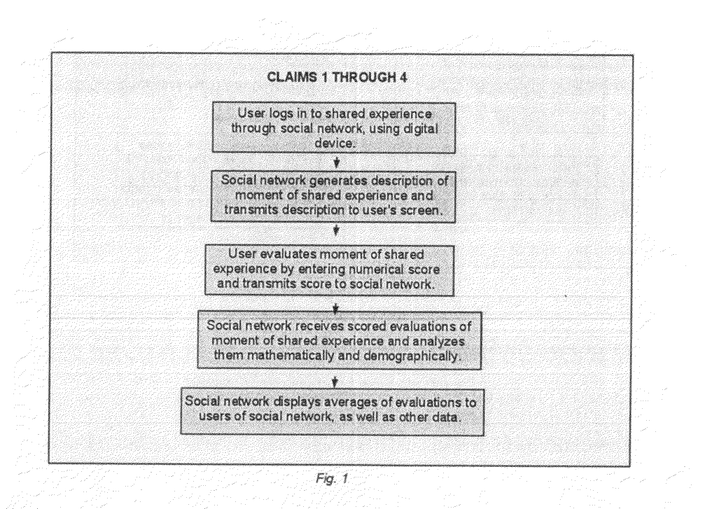

FIG. 2 of the drawing is a functional flow chart which describes, in linear temporal order, the method by which Claims 5 through 10 operate to result in the generation and display of the top user-generated text-based analytical evaluation (or “top comment”) of each distinct shared experience (or “moment”), as well as other analyses.

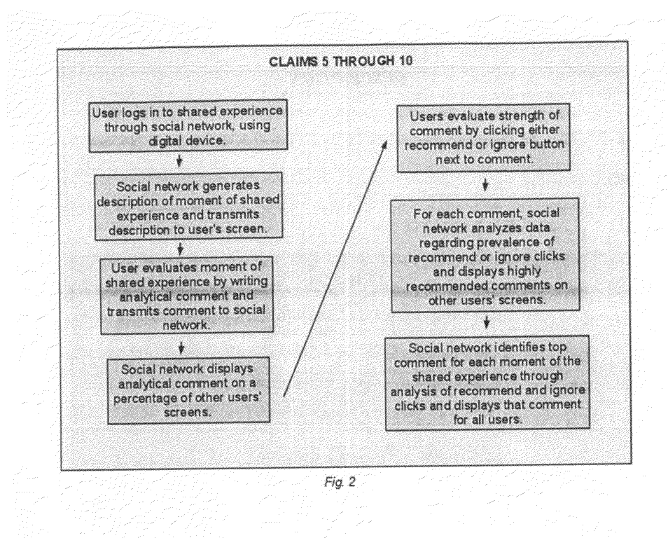

### DESCRIPTION OF THE PREFERRED EMBODIMENT OF THE INVENTION

The preferred embodiment of the invention, as illustrated in the accompanying drawings, is a social network accessible by all digital and electronic devices and that permits users to create profiles, log in to join communities of users experiencing the same event, and submit numerical ratings and analytical comments relating to distinctly identified moments within that shared experience.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method for requesting, collecting, aggregating, and analyzing numerical evaluations of shared distinct experiences (“moments”) by users of a social network who are witnessing a shared event.

2. The method in claim 1, wherein the moment is described by a source author who is a spectator of the shared event and then that moment's description is displayed to users of the social network that have logged in to the same event.

3. The method in claim 1, wherein the users of the social network are able to evaluate the moment by entry of their numerical evaluation into the social network interface, which entries are then sent to a data server operated by the social network.

4. The method in claim 1, wherein internal protocols within the social network aggregate and analyze the numerical evaluations of the moment by the users of the social network, including the average numerical evaluation of the moment by users of the social network, and other mathematical calculations.

5. A method for requesting, collecting, displaying and ranking analytical evaluations of shared distinct experiences (“moments”) by users of a social network who are witnessing a shared event.

6. The method in claim 5, wherein the moment is described by a source author who is a spectator of the shared event and then that moment's description is displayed to users of the social network that have logged in to the same event.

7. The method in claim 5, wherein the users of the social network are able to input text-based analytical evaluations of the moment into the social network interface, which text-based analytical evaluations are then sent to a data server operated by the social network.

8. The method in claim 5, wherein internal protocols within the social network distribute the analytical evaluations of the moment for display to other users of the social network, and wherein a user of the social network may communicate to the social network whether he or she finds that the analytical evaluation is valuable.

9. The method of claim 5, wherein those analytical evaluations that have been identified as valuable to a user of the social network are then displayed to a larger number of users for their assessment of whether the analytical evaluation is valuable.

10. The method of claim 5, wherein internal protocols within the social network analyze the number and percentage of users of the social network that find the analytical evaluation valuable, and rank the analytical evaluations of the moment from most valuable to least valuable, and displays the most valuable to the users of the social network that have logged in to the same event.
